(19) United States
(12) Patent Application Publication
(10) Pub. No.: US 2008/0212910 A1
(43) Pub. Date: Sep. 4, 2008

(54) BEARING ARRANGEMENT FOR DRYER CONVEYOR

(76) Inventor: Wayne Crooks, Madison, OH (US)

Correspondence Address: PEARNE & GORDON LLP, 1801 EAST 9TH STREET, SUITE 1200, CLEVELAND, OH, 44114-3108, US

(21) Appl. No.: 11/681,210

(22) Filed: Mar. 2, 2007

(51) Int. Cl. F16C 35/00; F26B 13/10

(52) U.S. Cl. 384/440; 34/523

(57) ABSTRACT

A bearing mounting system for a roller conveyor used in a hot air dryer, comprising an elongated bearing support cartridge having an elongated base with individual bearing carriers distributed between the ends of the base and each being arranged to carry a bearing sleeve segment of the type that has a bearing surface that lies in an imaginary cylinder such that an axis of the bearing surface lies in a horizontal plane perpendicular to the length of the cartridge and corresponds to the axis of rotation of a roll of the conveyor, the cartridge having mounting elements distributed at least on its ends for mounting to a frame of the dryer, the individual bearing carriers being installable and removable on and off the dryer frame only as a unit with other portions of the cartridge. The bearing sleeve segments and bearing carriers can be provided with interlocking grooves and tabs to stabilize the positioning of the bearing sleeve segments while allowing a relatively loose fit between the bearing sleeve segments and the bearing carriers.

### BACKGROUND OF THE INVENTION

The invention relates to roller conveyors and, more particularly, to improvements in bearing systems for the conveying rollers of hot air dryers.

### PRIOR ART

Industrial forced hot air dryers are used in the manufacture of sheet or board-like products, such as drywall, ceiling tile, wood-based panels, rigid insulation, and various other building products. These dryers typically use rollers to convey raw, moisture laden material through the dryer while hot air is circulated through the dryer so that excess moisture is removed and the material is converted from a wet layer to a more rigid self-supporting intermediate or final product. It has long been customary to rotationally support the conveyor rollers on carbon sleeve-like bearings. Originally, the bearings were configured to completely encircle the roller shafts. In more recent times, half sleeves have been employed. Also in recent times, polytetrafluoroethylene as well as ceramic material have been used to make roller shaft bearings. The carbon and polytetrafluoroethylene materials are characterized by being low in friction, abrasion-resistant, and resistant to thermal degradation in the hot air environment found in the subject dryers.

A typical dryer has several vertically spaced levels or decks with the rollers all being parallel to each other and at each deck being spaced along a common imaginary horizontal plane that extends through the dryer. The bearings are usually supported in individual brackets that are each secured to dryer frame members often called cage angles by pairs of bolts. Thus, the regular practice is to provide a bearing mount at each roller end that is wholly independent from the other bearing mounts. While this technique has served the industry for decades, if not nearly a century, it has disadvantages which include associated manufacturing costs of the dryer frame and bearing mounts and the labor involved in assembling and securing individual bearing units.

### SUMMARY OF THE INVENTION

The invention provides improvements in bearings and bearing mounts for roller conveyors of industrial dryers. Bearings of the present invention take the general form of partial cylindrical sleeves or arcuate segments and can include axially oriented slots that serve to stabilize the bearing during service. In a preferred version of the bearing, the segments subtend an arc that is somewhat less than 180 degrees and can be about 120 degrees, for example. The invention further provides a bearing system in which a plurality of bearing segment carriers are disposed on a common base, typically at a regular spacing between one another. The disclosed unitary base and multiple carrier system enables a whole section of bearing carriers for one side of a deck to be manufactured and subsequently installed with reduced manufacturing costs and reduced assembly time.

The disclosed bearing system includes a novel bearing retainer capable of holding multiple bearing segments in place at respective bearing carriers. The retainer can be held in operational position and released from this position by manipulating a limited number of fastening elements thereby retaining or releasing multiple bearing segments in an expeditious manner. This feature makes the original assembly of a conveyor deck quicker and, later reduces the effort required to release the bearing segments for inspection and for replacement when a bearing is excessively worn. Furthermore, with the disclosed versions of the unitary bearing carrier base and unitary bearing retainer, the bearing segments can be removed and replaced with minimal effort involving the quick release of the retainer, limited lifting of the associated roller, and ejection of a spent bearing with its new replacement. That is, a new bearing is positioned on a side of the base remote from the roller and is aligned coaxially with the spent bearing. With the roller shaft lifted slightly out of its operating position, the new bearing is pushed against the worn bearing causing the latter to be ejected from the respective bearing carrier pocket.

The bearing segment affords several advantages, including a considerable savings in material over a full circumference bearing. The bearing surfaces at the ends of the arc are at a considerable incline, i.e. about 30 degrees from the horizontal allowing dust and other debris to shed and be carried off by the effects of gravity and vibration thereby protecting the actual interface area between the bearing support surface and the shaft. The axial or longitudinal slots in the wall of the bearing at the arcuate ends are engaged by surfaces of the bearing retainer. The parts forming these surfaces are, while being proportioned to provide a relatively loose mutual fit at rest, are arranged to prevent rotation of the bearing and, importantly, to minimize skewing of the bearing such that its axis does not become out of parallelism with the shaft to a degree that is detrimental to the performance or life of the bearing.

### BRIEF DESCRIPTION OF THE DRAWINGS

FIG. 1 is an exploded perspective view of parts of a bearing system incorporating aspects of the invention;

FIG. 2 is a plan view of a blank used to make an elongated base of the bearing cartridge assembly of the invention;

FIG. 3 is a side elevation of the base after it has been formed into an elongated inverted U-shape;

FIG. 4 is an end view of the base;

FIG. 5 is a plan view of a blank used to make a bearing retainer of the bearing cartridge assembly;

FIG. 6 is a side elevational view of the bearing retainer after it has been formed into an elongated inverted U-channel;

FIG. 7 is an end view of the bearing retainer;

FIG. 8 is a partial side elevational view of a cartridge assembly constructed in accordance with the invention;

FIG. 8A is a fragmentary elevational view of the bearing cartridge assembly mounted on a cage angle and portions of a roller and roller shaft in their respective assembled positions when supported by a bearing of the bearing cartridge assembly.

FIG. 9 is an enlarged axial end view of a bearing constructed in accordance with the invention and in its environment in the bearing cartridge assembly;

FIG. 10 is a radial view of the bearing of FIG. 9;

FIG. 11 is a side view of the bearing of FIG. 9;

FIG. 12 is an enlarged axial end view of a modified bearing constructed in accordance with the invention and in its environment in the bearing cartridge assembly;

FIG. 13 is a radial view of the bearing of FIG. 9;

FIG. 14 is a side view of the bearing of FIG. 9;

FIG. 15 is an enlarged axial end view of another bearing constructed for use with the invention and in its environment in the bearing cartridge assembly;

FIG. 16 is a radial view of the bearing of FIG. 9; and

FIG. 17 is a side view of the bearing of FIG. 9.

### DESCRIPTION OF THE PREFERRED EMBODIMENTS

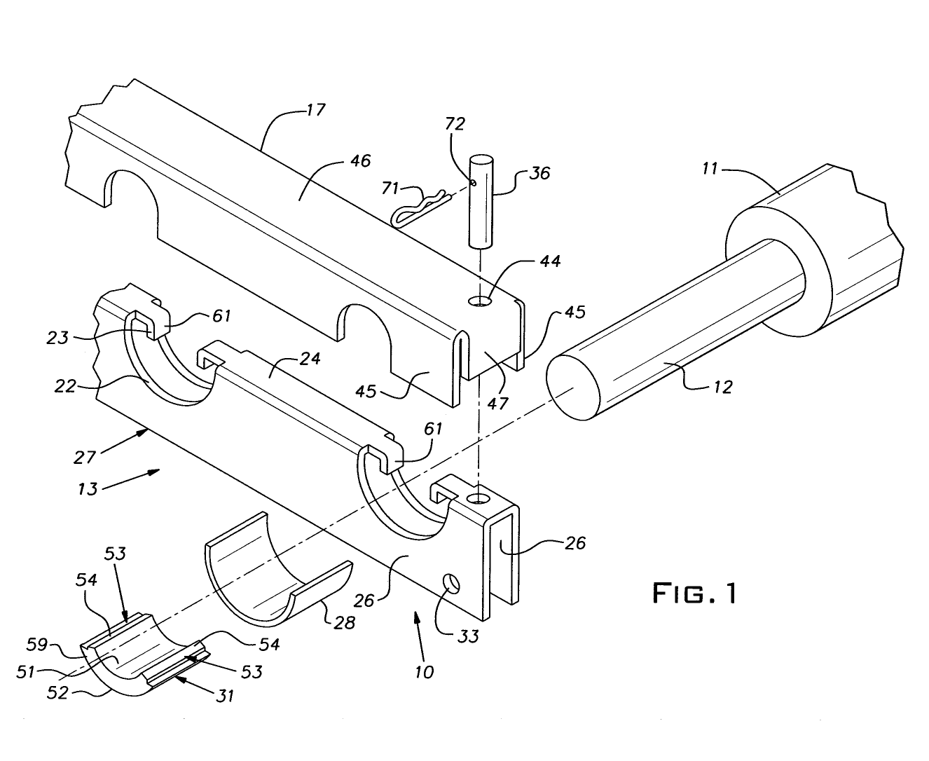

Referring now to the figures, and in particular to FIG. 1, there is shown a bearing system 10 for use in a roller conveyor for a hot air dryer. Such dryers are used for removing moisture from slurries or wet layers of solids such as that formulated in the production of drywall, ceiling tile, and like board products. Typically, the dryer has several layers or decks of roller conveyors. At each deck, a plurality of parallel rollers are serially arranged side-by-side in a horizontal plane with their axes parallel to one another and collectively forming a conveyor. Rollers 11 are all driven in a common rotational direction and mutually support and convey a moisture laden layer of material in the dryer. Hot air is forced through the dryer over the mat or layer of material being conveyed to absorb moisture. Typically, a burner utilizing natural gas, coal or other fuel, known in the art, heats the air and a blower forces it through the dryer. As is common, the rollers 11, which are typically all of the same construction, are carried on associated round steel shafts 12. Sprockets, not shown, on one end of each of the shafts 12 are driven in the conveying direction by an endless chain.

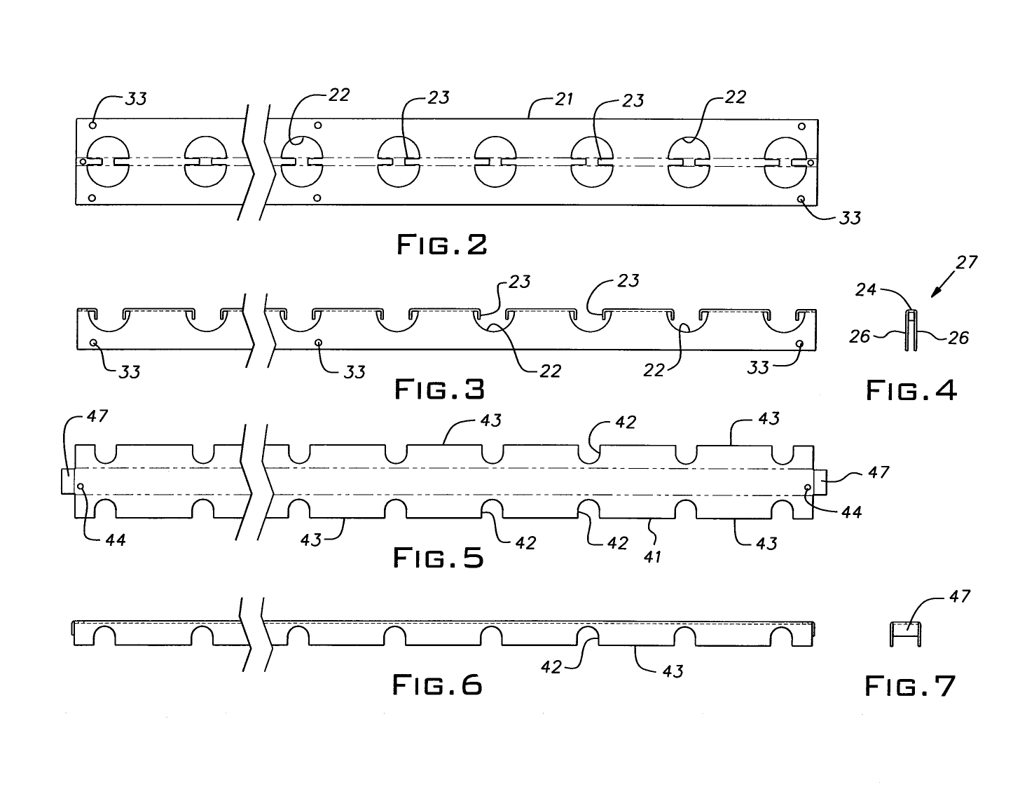

The bearing system for the conveyor rollers 11 of a single deck or level comprises a cartridge assembly 13 mounted on a horizontally extending frame member 14, sometimes called a cage angle in the industry. It will be understood that a cartridge assembly 13 is provided at each side of a conveyor deck or level, that is, at each of the ends of the rollers 11. The bearing cartridge assembly 13 comprises an elongated base unit or rail 16 and a complementarily shaped retainer 17. In the illustrated example, the unitary base 16 and unitary retainer 17 are made to accommodate a plurality of eleven (11) bearings, but it will be evident that a cartridge assembly 13 can be made to accommodate other numbers of bearings as needed or desired. The base unit 16 and retainer 16 can be fabricated from 12 gauge steel sheet, for example. FIGS. 2 and 5, respectively, illustrate planar sheet metal preforms or blanks of the base unit 16 and retainer 17.

The base unit blank, designated 21, shown in FIG. 2, has ovoid holes 22 punched out at each of the ultimate bearing centers. At the minor axis of the holes 22, opposed tabs 23 are left in the sheet metal stock. After the holes 22 are formed in the blank, the blank is folded into an elongated narrow U-shaped channel with a bight or web 24 aligned with the tabs 23 and with opposed sides or legs 26 depending from the web 24. After the blank 21 is formed into a channel 27 round, preferably semi-cylindrical steel shells 28 are inserted into the holes 22 and permanently fixed in place such as by welding to the edges of the holes at 29. An end view of the base unit 16 in FIG. 8A reveals that the shells 28 are longer in the direction of their axes than the outside width of the base channel 27. The shells 28 are fixed to the channel 27 such that they project laterally of the channel further at one side (to the left in FIG. 8A) than the other side. The shells 28 are concave with reference to the upper face of the base unit 16 so that they form carriers or seats for bearings 31 that rotationally support the shafts 12 of the conveyor rollers 11.

In conventional style dryer construction and, in particular, when existing dryers are retrofitted with the bearing cartridge assemblies 13, the inside dimension of the base channel 27 is sized to slip over a vertical leg 32 of a cage angle 14. This leg thickness may be ⅜″ or a similar dimension, or an equivalent metric dimension. The legs of the base unit channel 27 are drilled, punched, or otherwise formed with a limited number of aligned pairs of holes 33, for example, a pair adjacent each end and a pair at mid-length of the base unit 16, located to line-up with holes existing in the respective cage angle 14. A like number of bolts 34 assembled through these holes fix the base unit 16 and ultimately the entire cartridge assembly 13 in place. At each end, the base unit channel 27 has a vertical pin welded or otherwise permanently attached to it so that it extends upright to register with the bearing retainer 17 as explained below.

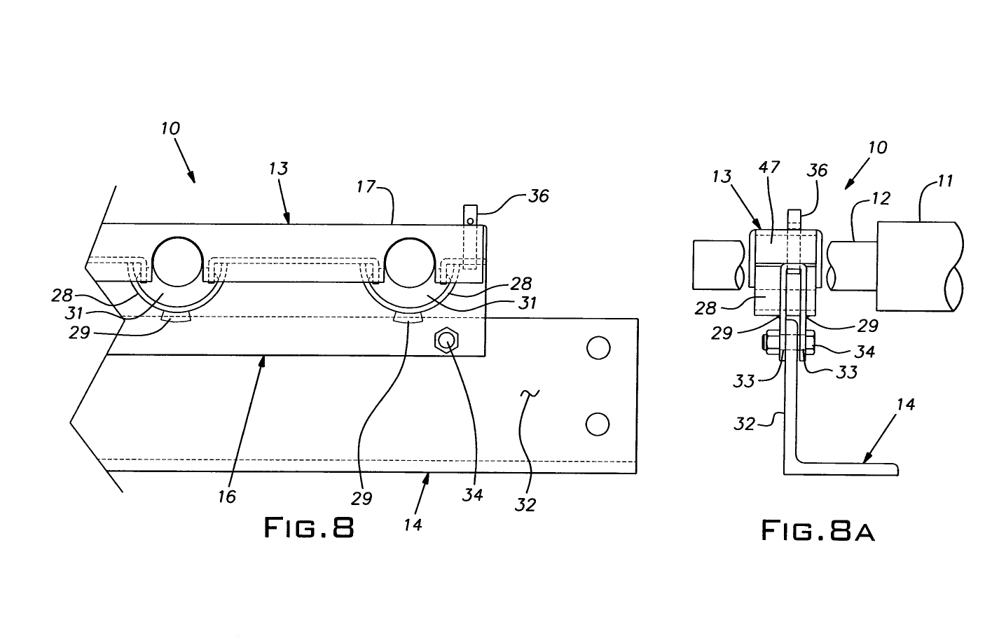

A retainer blank 41 shown in plan view in FIG. 5 is an elongated flat strip of steel punched with pairs of aligned slots 42 on its opposite longitudinal edges 43. The slots or notches 42 have round inner ends and are sized to fit over the roller shafts 12 with a small clearance. The retainer blank or sheet 41 is folded into a U-shape as shown in FIG. 7 with an inside width sized to slip over the channel 27 of the base unit 16. Holes 44 are formed in the ends of a web or bight 46 of the retainer 17 to receive the pins 36 on the base unit 16 and thereby be indexed to the base unit. Tabs 47 at each end of the retainer 17 are extensions of the web 46 and are bent down and dimensioned to abut the web 24 of the base unit channel 27 to properly vertically locate the retainer 17 above the base unit 16. The retainer 17 serves as a cover or close fitting hood to protect the bearings 31 from dirt, dust and other debris. Still further, the bearing retainer 17 restrains the bearing segments 31 radially by limiting radial displacement of the roller shafts 12 which, in turn, prevent the bearing segments from lifting radially out of the carrier shells 28.

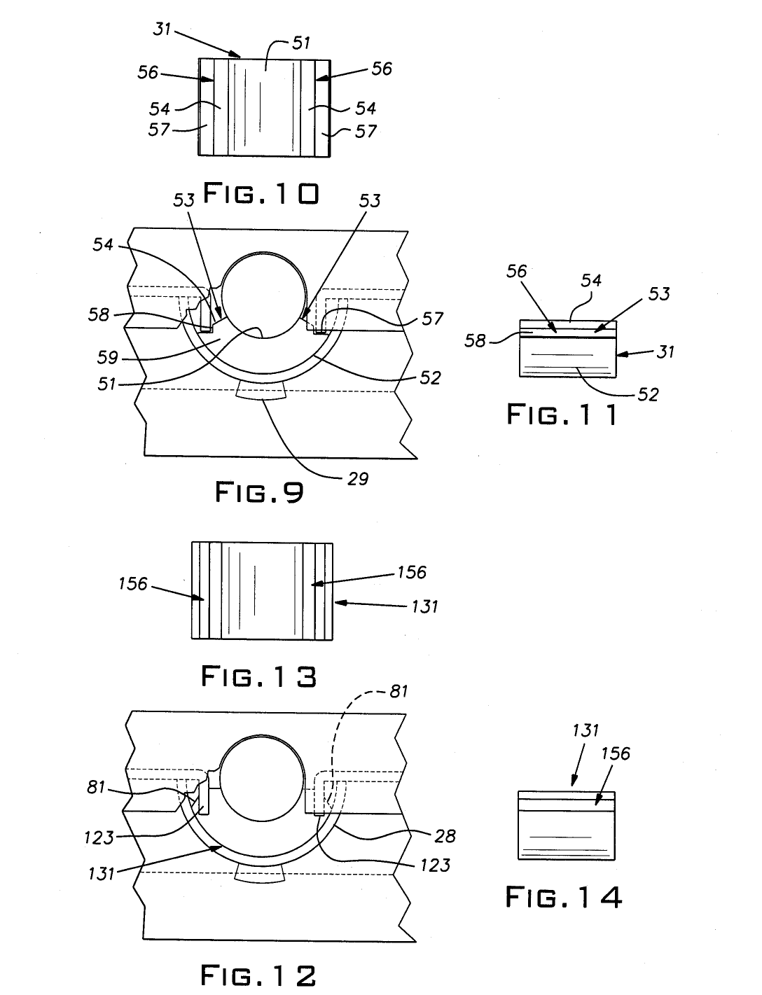

FIGS. 9-11 illustrate one form of a preferred bearing 31, a plurality of which are assembled in the cartridge assembly 13. The bearing 31 has a profile when viewed axially with reference to the axis of rotation of a roller 11, which is an arcuate segment of a hollow generally circular cylinder subtending an arc of nominally about 120 degrees. The bearing 31 has an internal cylindrical bearing surface 51 and an outer surface 52 that is also cylindrical and concentric with the bearing surface. The radius of the bearing surface 51 is nominally the same size as that of the roller shaft. Typically, the roller shaft will be 1¼″ or metric equivalent in diameter, but may be somewhat smaller or larger as required. The length of the bearing 31, measured in the direction parallel to the axis of the surface 51 is typically about 1 7/16″ or metric equivalent, but can be somewhat smaller or larger as desired.

At the ends of the arcuate span of the bearing 31 are generally radial faces 53. Adjacent the inner bearing surface 51, these faces are preferably truly or nearly radial so that they are inclined from the horizontal at an angle of about 30 degrees. This inclination of these areas 54 serves to shed dust and other debris that may be generated during operation of the dryer and rotation of the rollers 11 so as to carry such dirt and debris away from the interface of the bearing surface 51 and surface of the roller shaft 12 under the influence of gravity and any vibratory forces, as well as a wiping action on the leading side of the rotating roller shaft. Because the bearing 31 subtends an arc substantially less than 180 degrees, the roller shaft 12 overlies the exposed arcuate ends of the interface of its surface and the bearing surface 51 thereby tending to shield this area from falling dirt and debris.

The radial faces 53 are, additionally, characterized by the presence of axial slots or grooves 56, outward of the radial areas 54. The grooves 56 are shaped with planar surfaces 57, 58 that in the views of FIGS. 8 and 9 lie in respective planes that are chordal or tangential to imaginary cylinders concentric with the bearing surfaces 51, 52. The surfaces 58 lie in planes substantially perpendicular to an imaginary plane intersecting the radial faces 53. The tabs 23 associated with the holes 22 in the base unit 16 are bent down out of the plane of the bight 24 so that they are received in the grooves 56. Vertical surfaces 61 of the tabs 23 are arranged to abut vertical surfaces 58 of the grooves 56 and effectively restrain the bearing 31 from any cocking or skewing in the pocket of the shell 28 in which it is received. Such skewing of the bearing where its axis is misaligned with the axis of the roller shaft 12, can lead to excessive and/or unpredictable wear of the bearing. The bearing material is preferably a substance that exhibits low friction, abrasion resistance and durability when exposed to the temperatures existing in the dryer. Carbon and polytetrafluoroethylene are examples of suitable materials.

From the foregoing disclosure, it will be understood that the cartridge assembly 13 is capable of receiving and holding a plurality of bearings 31 in a horizontal array. The plurality of bearings 31 are held in position against axial movement by the opposed legs, designated 45, of the inverted channel-shaped retainer 17. More specifically, the inside surfaces of the legs 45 are arranged to axially constrain the bearings 31 by abutting end faces 59 of the bearings 31 which lie in planes transverse to the axes of the bearings. The slots 42 in the retainer legs 45 are proportioned to clear their respective roller shafts 12. As earlier suggested, the cartridge assembly can be installed in a dryer of generally conventional construction, having what is known as cage angles or like frame elements 14 by simply bolting it in using the holes 33 and bolts 34. Such an arrangement where all of the bearing supports, represented by the shells 28 are installed with a few bolts is a great savings in manufacturing costs, manufacturing labor, and assembly labor, over traditional arrangements where these bearing mounts have been individually mounted on a cage angle or its equivalent.

The bearing retainer 17 is held in place on the pins 36 by hitch pins 71 (FIG. 1) assembled through cross holes 72 drilled through the pins just above the upper surface of the retainer web 46. The retainer 17 can be quickly and easily removed from the base unit 16 by removing the hitch pins 71 and lifting the retainer off the base unit pins 36 thereby exposing all of the bearings 31 for inspection and releasing the same for removal and replacement. With the retainer 17 lifted from the base unit 16, the bearings 31 are unrestricted axially but for the weight imposed by a roller 11 through the roller shaft 12. Consequently, a spent bearing 31 can be displaced by simply lifting its associated roller shaft 12 slightly to release its load from the spent bearing and pushing a fresh bearing against it in the axial direction so that the fresh bearing ejects the spent bearing from the receiving pocket formed by the associated shell 28 and is automatically replaced by this new bearing when the latter is fully received in the shell. It will be noted that in the fully received position, the new or fresh bearing 31 is substantially flush with both ends of a respective shell 28.

FIGS. 12-14 illustrate a second form of a bearing 131 that has an increased arcuate length. The arcuate length is advantageously slightly less than 180 degrees enabling two pieces to be cut from a cylindrical blank. The bearing 131 fits comfortably into a bearing carrier shell 28 with a nominal 180 degree expanse with a clearance shown at opposite sides 81. The bearing 131 can have the ID and OD and length of the bearing 31, for example. Tabs 123 are received in grooves 156 and serve the same purposes as that described in connection with the tabs 23 and grooves 56 described above in connection with the bearing 31. In simple terms, the tabs 131 work like keys to ensure that the bearing remains in proper orientation and therefore provides a full service life.

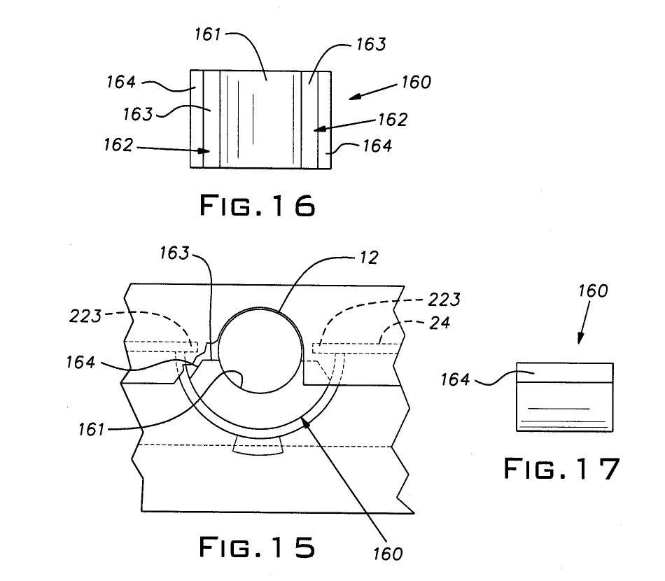

FIGS. 15-17 illustrate still a further form of a bearing 160 useful in practicing the invention. The bearing 160 at a bearing surface 161 surrounds nearly 180 degrees of a roller shaft 12. The bearing 160 has ID, OD and length dimensions corresponding to the bearing 31. Diametrically opposite faces 162 of the bearing have coplanar flat areas 163 lying in a plane adjacent an imaginary plane aligned with the axis of the bearing surface 161 and downwardly sloping areas 164 at outlying zones of the faces 162. When the bearing 160 is employed, tabs 223 corresponding to the tabs 23 of the embodiment of FIGS. 1-11, are coplanar with the web 24 of the base channel 27.

While the invention has been shown and described with respect to particular embodiments thereof, this is for the purpose of illustration rather than limitation, and other variations and modifications of the specific embodiments herein shown and described will be apparent to those skilled in the art all within the intended spirit and scope of the invention. For example, the multiple bearing cartridge of the invention can be used in dryers, often used for example in veneer manufacture, where roller shaft bearings are suspended or hung from above. In such cases, the disclosed multiple bearing cartridge can be employed with suitable mounting adapters. Accordingly, the patent is not to be limited in scope and effect to the specific embodiments herein shown and described nor in any other way that is inconsistent with the extent to which the progress in the art has been advanced by the invention.

What is claimed is:

1. A bearing system for a roller conveyor in a hot air dryer or the like comprising an elongated rail having a series of bearing seats regularly spaced along its lengthwise direction, the bearing seats each being arranged to receive and vertically support a bearing sleeve segment, a sleeve bearing segment disposed in each of said bearing seats, the bearing sleeve having an open upper face and a bearing surface, the bearing surface lying in an imaginary cylinder having an axis adjacent said open upper face, the bearing surface extending along an arc of the imaginary cylinder through an angle less than 180 degrees such that the shaft overlies edges of the bearing surface at said upper face.

2. A bearing system as set forth in claim 1, wherein the bearings each have a downwardly inclined surface at their arcuate ends.

3. A bearing system as set forth in claim 1, wherein said rail is a steel weldment.

4. A bearing system as set forth in claim 1, wherein said bearing seats are spaced uniformly along the length of the rail.

5. A bearing system as set forth in claim 1, including a unitary bearing retainer arranged to axially locate said plurality of bearings in their respective seats.

6. A bearing system as set forth in claim 5, wherein said bearing retainer is arranged to release all of said bearings when said bearing retainer is removed from an operative position.

7. A multiple bearing cartridge comprising a plurality of bearing seats all arranged in a row and a common plane, said cartridge being arranged to bolt onto the vertical side of a cage angle of an industrial roller conveyor of a hot air dryer.

8. A multiple bearing cartridge as set forth in claim 7, including a common retainer that overlies bearing segments positioned in said bearing seats.

9. A bearing cartridge as set forth in claim 8, wherein said common cover serves to axially restrain said bearing segments in their respective seats.

10. A bearing cartridge as set forth in claim 8, wherein said common cover is in the form of an inverted channel.

11. A bearing cartridge as set forth in claim 7, wherein said bearing seats are formed by cylindrical shell segments.

12. A bearing cartridge as set forth in claim 8, wherein said common cover is indexable to a base unit carrying said plurality of bearing seats.

13. A bearing cartridge as set forth in claim 12, wherein said cover is indexable to said base unit with vertically extending pins.

14. A bearing mounting system for a roller conveyor used in a hot air dryer, comprising an elongated bearing support cartridge having an elongated base with individual bearing carriers distributed between the ends of the base and each being arranged to carry a bearing sleeve segment of the type that has a bearing surface that lies in an imaginary cylinder such that an axis of the bearing surface lies in a horizontal plane perpendicular to the length of the cartridge and corresponds to the axis of rotation of a roll of the conveyor, the cartridge having mounting elements distributed at least on its ends for mounting to a frame of the dryer, the individual bearing carriers being installable and removable on and off the dryer frame only as a unit with other portions of the cartridge.

15. A bearing mounting system as set forth in claim 14, the bearing carriers being arranged to permit the bearing sleeve segments to be installed by sliding axially along a direction parallel to the shaft and thereby enabling a bearing segment to be replaced without removal of the cartridge from the frame of the dryer.

16. A bearing mounting system as set forth in claim 14, including a unitary bearing retainer arranged to axially restrain all of the bearing sleeve segments in place on said base.

17. A bearing mounting system as set forth in claim 16, wherein said retainer is arranged to restrain said bearing sleeve segments in a radial direction by overlying the shaft of each respective bearing sleeve segment and restraining said shaft from radial movement.

18. A bearing mounting system as set forth in claim 17, wherein said retainer has provisions for mounting on said elongated base.

19. A bearing mounting system as set forth in claim 18, wherein said retainer is located on said base with pins and receiving holes provided by said retainer and said base.

20. A bearing mounting system as set forth in claim 14, including a sleeve segment bearing in each of said bearing carriers, said segment bearings having a bearing surface lying in an imaginary cylindrical surface, said bearings having arcuate ends, said arcuate ends having grooves extending parallel to an axis of the imaginary cylindrical surface, said cartridge having tabs received in said grooves.

21. A bearing sleeve segment for service in a hot air dryer roller conveyor, the segment having a cylindrical bearing surface subtending an arc of about 120 degrees or more, the bearing surface being concentric about an imaginary axis, the segment being formed of a relatively inert low friction material resistant to thermal degradation at elevated temperatures existing in a hot air dryer roller conveyor, the bearing sleeve segment having arcuate end surfaces extending between the bearing surface and an outer boundary surface, the end surfaces having grooves with surface portions lying in planes parallel to said axis and generally perpendicular to an imaginary plane that passes through said end surfaces.
